(19) United States
(12) Patent Application Publication
(10) Pub. No.: US 2008/0224805 A1
(43) Pub. Date: Sep. 18, 2008

(54) PROPORTIONAL MAGNET

(75) Inventors: Christian Becker, Neunkirchen (DE); Matthias Rottmann, Neunkirchen (DE); Jurgen Schonlau, Walluf (DE); Bernhard Kirsch, Mandelbachtal (DE)

Correspondence Address: ESCHWEILER & ASSOCIATES, LLC;NATIONAL CITY BANK BUILDING, 629 EUCLID AVE., SUITE 1000, CLEVELAND, OH, 44114, US

(73) Assignee: Thomas Magnete GmbH, Herdorf (DE)

(21) Appl. No.: 12/047,029

(22) Filed: Mar. 12, 2008

(30) Foreign Application Priority Data
Mar. 12, 2007 (DE) 102007012151.4

(51) Int. Cl. H01F 7/08

(52) U.S. Cl. 335/277

(57) ABSTRACT

The invention relates to a proportional magnet, including a winding carried by a coil body, two pole shoes which project into the coil body from opposite sides and which are spaced apart axially from one another, and a gap provided between the pole shoes. The invention further includes a magnet armature, which is arranged within the winding in an axially displaceable manner substantially parallel to the longitudinal axis thereof. The axial movement of the magnet armature can be transmitted to a valve member. The invention still further includes an electrically conductive element, wherein the magnet armature can be moved through the element, wherein the element is formed from a basic body having an electrically conductive layer, and wherein the electrically conductive layer is applied separately to the basic body.

### CLAIM OF PRIORITY

Priority is claimed to German Patent application 10 2007 012 151.4, filed on Mar. 12, 2007, the entire disclosure of which is incorporated by reference herein.

### FIELD OF THE INVENTION

The invention relates to a proportional magnet, in particular for the actuation of a hydraulic valve.

### BACKGROUND OF THE INVENTION

Proportional magnets are used in diverse technical fields. Such magnets can be driven in a pulse-width-modulated manner, wherein the voltage applied to the magnet is periodically switched on and off. The frequency of this periodic signal is referred to as the PWM frequency. A proportional magnet driven in a pulse-width-modulated manner is shown for example in German Patent DE 44 23 122 C2.

Conventional proportional magnets generally comprise a coil which together with the iron circuit forms an inductive load. The inductive load has the effect that the current flowing through the magnet first increases abruptly and then decreases approximately linearly before a renewed abrupt increase commences. The average current flowing in the coil is in this case proportional to the product of the coil resistance, the battery voltage and the duty ratios of the modulated voltage. The current fluctuates to a relatively great extent within a duty period. The difference between the minimum and maximum current within a period is referred to as the current ripple. In principle, the current ripple is dependent on the duty ratio, the PWM frequency and the properties of the magnetic circuit. However, the relationship between these quantities is highly non-linear and, consequently, cannot be specified with general validity for all magnets.

The current ripples mentioned above exert a periodically fluctuating force on the armature of the proportional magnets, which force brings about a micromovement of the armature that is dependent on the mechanical properties of the load at the output of the proportional magnet. The micromovement is generally referred to as dither and prevents the armature from adhering to the wall of its mount. As a side effect the PWM modulation thus brings about a reduction of the mechanical hysteresis of the magnet.

The driving of the magnet by means of pulse-width-modulated signals is subject to the disadvantage, however, that a considerable noise emission occurs in this case. In the case of the proportional magnet in accordance with DE 44 23 122 C2, these noise emissions are caused by radial movements of the magnet armature, wherein the radial movements, by way of positive feedback, bring about an increase in the transverse forces and hence a metastable state of the armature. The geometry of a copper tube which, in accordance with DE 44 23 122 C2, is arranged radially between the coil body and the pole shoes and located outside the magnetic circuit, and the accompanying magnetic interactions between the tube and the magnet armature are not able to counteract the disturbing radial movements of the magnet armature.

Various solutions are known in the prior art for suppressing noise emissions in the case of proportional magnets driven in a pulse-width-modulated manner. In order to suppress the noise emission, the PWM frequency in the driving is increased until the exciting force that arises as a result of the current ripple has fallen to an extent such that the armature movement fails to occur and therefore no noise is emitted. The disadvantage of this method, however, is that, as a result, the static friction between magnet armature and the latter's mounting sleeve or the like increases and the proportional magnet exhibits a disturbing hysteresis as a result.

A further solution for suppressing the noise emission consists in encapsulating the magnet armature by means of a sound-insulating sheathing. In addition to the high costs, this solution also has the disadvantage of impeding the heat dissipation at the magnet.

A further possibility for reducing the sound emission provides sound-insulating measures in the output of the magnet. In this case, the mass of the valve slide is increased and the stiffness of a restoring spring acting thereon is reduced, whereby the sound insulation is achieved. These measures are not effective, however, since they prevent only the secondary sound emission, but not the primary sound emission of the magnet itself.

Another possibility with regard to the sound emission provides a hydraulic damping in the armature space. For this purpose, the space above and below the two end faces of the armature is sealed relative to the surroundings. The armature piston has only a small, defined gap with respect to the surrounding mount. The two chambers above and below the end faces are filled with a viscous medium. The two chambers and the piston thus represent a viscous damper whose damping force is determined by the gap between piston and mount and by the viscosity of the medium. This solution is disadvantageous, however, insofar as the damping that can be achieved is greatly temperature-dependent and can also fluctuate uncontrollably as a result of manufacturing tolerances.

The prior art mentioned above makes it possible to minimize noise emissions by means of variations of the inductance of the PWM frequency, the hydraulic damping in the armature space and the stiffness of the mechanical system connected downstream of the magnetic armature. However, these measures also reduce the functional quality and the dynamic range of the system and considerably increase the hysteresis of the proportional magnet.

### SUMMARY OF THE INVENTION

The following presents a simplified summary of the invention in order to provide a basic understanding of some aspects of the invention. This summary is not an extensive overview of the invention. It is intended neither to identify key or critical elements of the invention nor to delineate the scope of the invention. Rather, its primary purpose is merely to present one or more concepts of the invention in a simplified form as a prelude to the more detailed description that is presented later.

In one embodiment, the invention is directed to proportional magnet which exhibits an improved noise emission without any impairment of its functional quality and with extremely simple and inexpensive means.

A proportional magnet according to one embodiment of the invention comprises a winding carried by a coil body, two pole shoes projecting into the coil body from opposite sides and which are spaced apart axially from one another. A gap is provided between the pole shoes, and a magnet armature is arranged within the winding in an axially displaceable manner substantially parallel to the longitudinal axis thereof, wherein the axial movement of the magnet armature can be transmitted to a valve member. The invention further comprises an electrically conductive element, being arranged in the gap, wherein the magnet armature can be moved through the element, wherein the element is formed from a basic body having an electrically conductive layer, and wherein the electrically conductive layer is applied separately to the basic body.

In one embodiment, the arrangement of the electrically conductive element within the gap is related to two geometrical features of the element. Firstly, a length of the element axially and substantially parallel to the longitudinal axis of the coil body is small because said length is restricted by the adjoining axial end faces of the pole shoes. Furthermore, the radial distance of the element with respect to a center axis of the coil body or of the magnet armature arranged in a displaceable manner on said center axis is small. These geometrical features of the electrically conductive element result in two advantageous effects with regard to the magnetic field: The small length of the element leads to a relatively greater curvature of the field lines of the magnetic field induced by said element. This means that the field lines of the magnetic field form an angle with the longitudinal axis of the coil body, but do not run parallel thereto. As a result of this, comparatively large radial force components act on the magnet armature in the direction of the center axis of the coil body if the magnet armature moves radially with respect to the winding. Furthermore, the comparatively small radial distance of the element with respect to the center axis of the coil body or with respect to the magnet armature has the effect that the change in the magnetic flux density assumes a relatively high magnitude if the magnet armature moves radially with respect to the winding. The change in the magnetic flux density with respect to the element enclosing the magnetic armature is different from zero in the case of a radial movement of the element relative to the winding, such that a current is induced in the element. Said current in turn generates in the element a magnetic field that acts on the magnet armature in the manner of a funnel. To put it another way, the magnetic field generated in the element brings about a funnel effect which forces the magnet armature back in the direction of the center axis of the coil body or back to said axis. In the case of a radial movement of the magnet armature, therefore, the magnetic field generated in the element precisely by said radial movement of the magnet armature gives rise to a self-stabilizing effect with respect to the center axis of the coil body for the magnet armature in the manner of the funnel effect explained.

The proportional magnet according to one embodiment of the invention further provides the advantage that the element as such does not have to be produced from a metallic material, but rather solely the electrically conductive layer which is applied separately on the basic body, forms a conductor track enclosing the magnet armature. Consequently, the production of the basic body can be achieved with more flexibility with regard to the manufacturing of said basic body and the corresponding material selection. By way of example, the basic body can be produced inexpensively from a plastic by means of injection molding.

In one advantageous embodiment of the invention, the element, if it is made of a metallic material, and the electrically conductive layer, respectively, can have a metallic coating that provides protection against corrosion. Such a coating can, in one example, be produced by chemical tin-plating or else electrolytic gold-plating. The coating therefore prevents an undesirable corrosion of the element and of the conductive layer, respectively, and therefore ensures a high functional reliability of the proportional magnet in conjunction with a long lifetime.

The above-explained small height of the element with respect to a longitudinal axis of the coil body can be obtained by the element being formed as a ring. The ring encloses the magnet armature in every position thereof with respect to the coil body or the winding. This ensures the advantageous curvature of the field lines of the magnetic field generated in the ring with respect to the longitudinal axis of the coil body.

In an advantageous embodiment of the invention, an internal diameter of the ring can be at most as small as the external diameter of the magnet armature, a displaceability of the magnet armature through the ring being ensured. In this case, the ring is brought with its internal circumferential area very close to an external circumference of the magnet armature without these components getting stuck together. Furthermore, an external diameter of the ring can be chosen to be at most as large as an external diameter of at least one of the two pole shoes. This has the effect firstly that the ring is still arranged within the air gap axially between the two pole shoes, and furthermore the length of the ring is maximal in this arrangement. Consequently, the eddy current generated in the ring during a radial movement of the magnet armature assumes a high magnitude, wherein a magnetic field generated by said eddy current damps the radial movement of the magnet armature and forces the latter back to the center axis of the proportional magnet or of the coil body. This has already been explained above as the funnel effect.

In an advantageous embodiment of the invention, the element or the ring can be produced from a metallic material, for example from copper or aluminum. This ensures a sufficiently high magnetic field which is generated in the element or the ring on account of the current induced therein.

The proportional magnet according to the invention is used as an actuation element in one embodiment for a proportional throttle valve in speed-dependent servo steering systems of vehicles. The disturbing noise level in conventional proportional magnets is pronounced particularly when there are instances of large current ripple, since the PWM signal commences in this range and full modulation is provided beforehand. In a servo steering system this range arises when the vehicle is being parked, idling and/or stopped. It is precisely in said range that the disturbing noise evolution becomes apparent in an unpleasant fashion owing to the lack of travel noise. The proportional magnet according to the invention provides a remedy here, as explained. Alternatively, a use of the proportional magnet according to the invention is possible in any other applications in which an oscillating axial drive movement is required. In the proportional magnet according to the invention, such drive movements can be generated by the pulse-width-modulated signals applied to the coil for driving the magnet armature, wherein a radial movement of the magnet armature and thus disturbing noise emissions are prevented by the electrically conductive element or the ring.

It has to be understood that the features mentioned above and those yet to be explained below can be used not only in the combination respectively specified but also in other combinations or by themselves, without departing from the scope of the present invention.

The invention will be described and explained in more detail below with reference to an exemplary preferred embodiment and with reference to the attached drawings.

### BRIEF DESCRIPTION OF THE DRAWINGS

FIG. 1 shows a longitudinal cross-sectional view of a proportional magnet according to the invention.

FIG. 2 shows a cross-sectional view along the line B-B from FIG. 1 or from FIG. 3.

FIG. 3 shows a longitudinal cross-sectional view of a proportional magnet according to the invention in a further embodiment.

FIG. 4 shows a diagram of a current as a function of time, for a coil of the proportional magnet from FIG. 1.

FIG. 5 shows a diagram of a force as a function of time, which force acts on a magnet armature of the proportional magnet from FIG. 1.

FIG. 6 shows a diagram of a noise level as a function of the driving current for the magnet from FIG. 1, in each case with and without a ring.

### DETAILED DESCRIPTION OF THE INVENTION

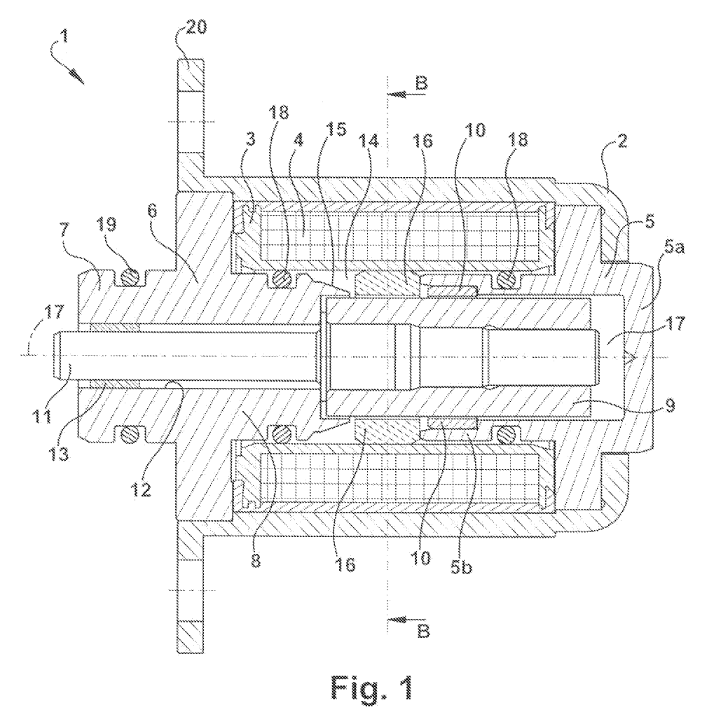

One embodiment of a proportional magnet 1 according to the invention is explained below with reference to FIGS. 1 to 6.

The proportional magnet 1 has a housing 2 produced from magnetic material, a winding 4 carried by a coil body 3 being accommodated in said housing. The winding 4 forms a coil for generating a magnetic field, wherein the magnetic housing 2 serves for guiding magnetic flux. The housing 2 is closed off at its axial ends in each case by a pole shoe, wherein the two pole shoes project into the coil body 3 from opposite sides.

A first pole shoe 5, also called yoke, consisting of a yoke disk 5a and a pole tube 5b, is shown on the right in the longitudinal cross-sectional view in accordance with FIG. 1. Opposite to the first pole shoe 5, that is to say shown on the left in the view in accordance with FIG. 1, the housing 2 is closed off by a second pole shoe 6, which is formed integrally from a valve sleeve 7 and a cone 8. Both pole shoes 5, 6 are in each case produced from magnetically permeable material.

A magnet armature 9 composed of magnetic material is accommodated within the pole tube 5b. The magnet armature 9 is guided in an axially displaceable manner within the pole tube 5b or the first pole shoe 5 by means of a guide bush 10 fixed to an internal circumferential area of the pole tube 5b. The magnet armature 9 comprises a cylinder having an internal hole in which an actuating rod 11 is fixed. The actuating rod 11 is led out from the valve sleeve 7 (toward the left in FIG. 1) through a hole 12 formed in the second pole shoe 6. A guide bush 13 within the hole 12 ensures that the actuating rod 11 is guided centrally within the hole 12 on the center axis 17.

A functionally governed gap 14 is provided axially between the first pole shoe 5 and the second pole shoe 6. The cone 8 as part of the second pole shoe 6 has a control cone 15 adjacent to said gap 14, said control cone having a contour falling in the direction of the gap 14 or of the magnet armature 9. Arranged in the gap 14 is a ring 16 situated radially between the coil body 3 or the winding 4 and the magnet armature 9. The ring is made of a non-magnetic, electrically conductive metallic material, where in one embodiment the material copper is appropriate for this. As an alternative to this, the ring 16 can also be made of aluminum or other suitable material. The longitudinal cross-sectional view of FIG. 1 illustrates that an internal diameter of the ring 16 is chosen to be slightly larger than an external diameter of the magnet armature 9. The consequence of this is that the ring 16 is arranged radially very close to the magnet armature 9, an axial displaceability of the magnet armature 9 through the ring 16 simultaneously being ensured. An external diameter of the ring 16 substantially corresponds to an internal diameter of the coil body 3. One advantageous feature of the ring 16 is that it has a comparatively small amount axially, i.e. parallel to the longitudinal axis 17 of the proportional magnet 1.

The proportional magnet 1 furthermore comprises a plurality of O-rings 18 that seal the coil body 3 with respect to the pole tube 5b and the cone 8. A further O-ring 19 is provided on an external circumferential area of the valve sleeve 7 in order to ensure sealing with respect to adjacent machine parts or the like. The proportional magnet 1 comprises a fixing flange 20 radially peripherally with respect to the cone 8, said fixing flange being formed for example integrally with the housing 2 and serving for fixing the proportional magnet 1 in a suitable manner.

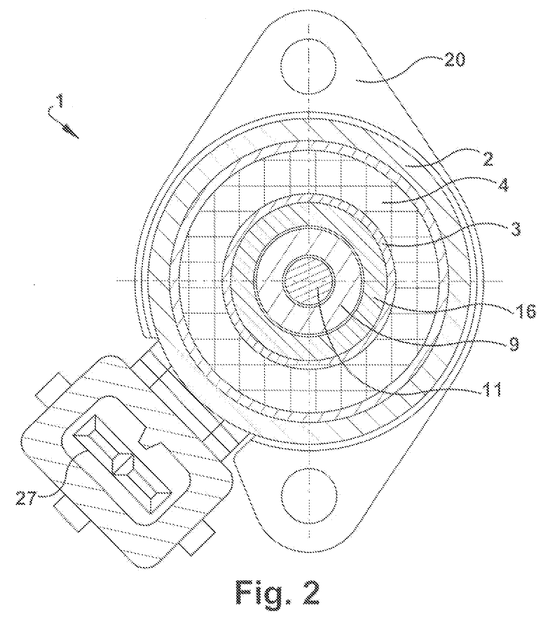

FIG. 2 shows a cross-sectional view of the proportional magnet 1 along the line B-B from FIG. 1. It clearly reveals that the ring 16 encloses the magnet armature 9 over the entire circumference. Electrical plug contacts 21 for supplying the coil 4 with voltage are provided on the housing 2.

The proportional magnet 1 serves, in one embodiment, as an actuating element for a proportional throttle valve, for example, for speed-dependent servo steering systems of vehicles or the like. Accordingly, the actuating rod 11 is connected to a valve element or the like, such that an axial movement of the magnet armature 9 with respect to the center axis 17 is transmitted to the valve element. The proportional magnet 1 is driven by means of a pulse-width-modulated voltage applied to the coil 4. On account of the magnetic field generated by the coil 4 in this case, the magnet armature 9 is moved to and fro within the first pole shoe 5 between a first and second end position. When the coil 4 is energized, the magnet armature 9 is displaced into its first end position (shown on the left in FIG. 1), in which an end side of the magnet armature 9 that faces the second pole shoe 6 is accommodated within the control cone 15. The above-explained falling contour of the control cone 15 in the direction of the gap 14 enables a largely constant magnetic force over the armature stroke. If the coil 4 is de-energized, then the magnet armature 9 is moved in the direction of its second end position, i.e. in the direction of the yoke disk 5a, by means of a spring prestress or the like.

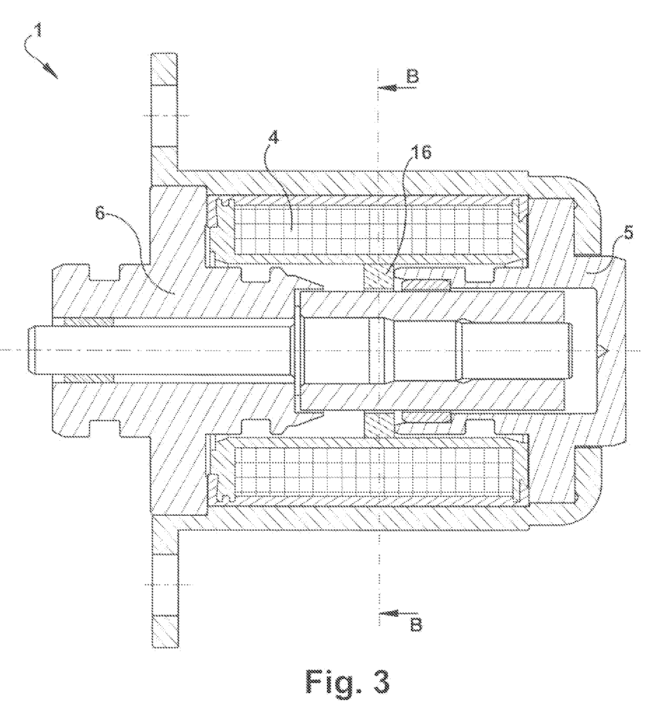

FIG. 3 shows a further embodiment of the proportional magnet 1 in a longitudinal cross-sectional view. This embodiment is identical to that from FIG. 1 with the exception that in this case the ring 16 has a smaller length parallel to the longitudinal axis 17. However, the functional principle of the proportional magnet 1 does not change as a result of this. A cross-sectional view along the line B-B from FIG. 3 corresponds to the illustration of FIG. 2 as explained above.

The invention functions now as follows:

As a result of a voltage being applied to the coil 4, a magnetic field is generated in said coil and acts on the magnet armature 9. Consequently, the magnet armature 9 is displaced within the pole tube 5b and through the ring 16 into its first end position. This has the effect of acting upon the valve element connected to the actuating rod 11. If, during this axial displacement, the magnet armature 9 also moves radially, that is to say essentially perpendicular to the center axis 17 of the proportional magnet 1, then a change in the magnetic field occurs and an eddy current is thus generated in the ring 16, which induces a magnetic field in an opposite direction therein. In this case, the geometry of the ring 16 leads to two effects: The small length of the ring 16 with respect to the longitudinal axis 17 leads to a relatively great curvature of the field lines of the magnetic field induced by the ring 16. This means that the field lines of the magnetic field form an angle with the center axis 17 of the coil body 3, but do not run parallel thereto. As a result, the magnetic field induced in the ring 16 exerts comparatively large radial force components on the magnet armature 9 in the direction of the longitudinal or center axis 17, wherein these radial forces force the magnet armature 9 back to the center axis 17 of the proportional magnet 1 in the manner of a funnel effect. This results in a self-stabilizing effect for the magnet armature 9 if the latter moves radially with respect to the center axis 17 within the ring 16. As a result, a radial movement of the magnet armature 9 is cancelled and disturbing noises are thus prevented.

A further effect of the ring 16 is provided by its comparatively small radial distance with respect to the center axis 17. This results in a high magnitude for the change in the magnetic flux density if the magnet armature 9 moves radially with respect to the center axis 17. As a result, the abovementioned radial force components which act on the magnet armature 9 assume a sufficiently high magnitude, such that the self-stabilizing effect explained is established in the manner of the funnel effect.

An essential advantage of the invention is given by the fact that due to the ring 16 and the effects thereof on the magnet armature 9, the undesirable radial movements of the magnet armature 9 and the resultant noise emissions are eliminated without the PWM frequency having to be altered for this purpose.

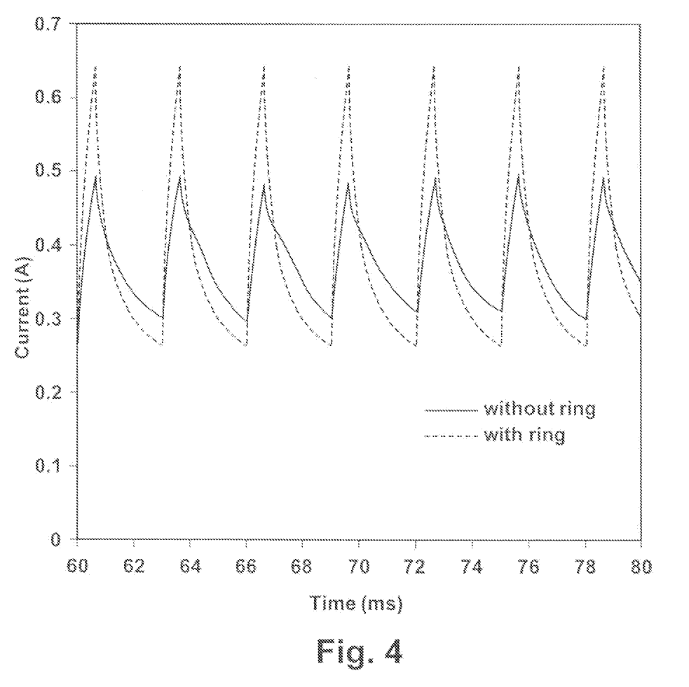

The effects of the proportional magnet 1 comprising the ring 16 are illustrated in comparison with a conventional solution without said ring in the diagrams of FIGS. 4 to 6.

FIG. 4 illustrates the current flowing in the coil 4 as a function of time, wherein the voltage applied to the coil 4, the PWM frequency and the duty ratio are constant in each case. The dashed curve in the diagram of FIG. 4 shows the proportional magnet 1 according to the invention with the ring 16, and the curve represented by the solid line shows a conventional proportional magnet without the ring 16. In the diagram, the curves are illustrated starting from a time of 60 msec such that a transient response of the coil 4 with rising average current has already abated. Accordingly, the average currents for the respective curves in this diagram are essentially constant. It can be found that the complex inductance of the proportional magnet 1 comprising coil 4 and ring 16 changes in such a way that instances of larger current ripple are generated in the coil 4 in comparison with the solution without a ring. This is caused by the eddy currents brought about in the ring 16.

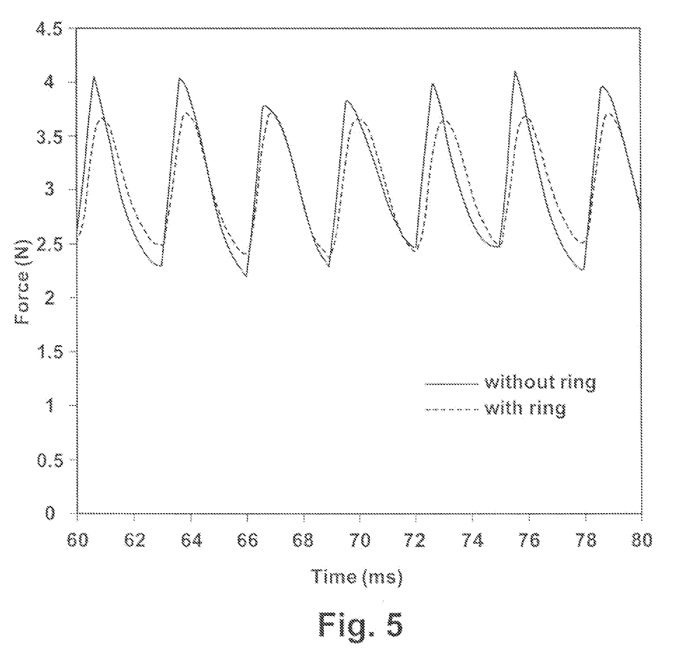

The force acting on the magnet armature 9 is plotted as a function of time in the diagram in FIG. 5, wherein, analogously to the illustration of FIG. 4, the voltage applied to the coil 4, the PWM frequency and the duty ratio are once again kept constant. The dashed curve of the diagram of FIG. 5 is assigned to the proportional magnet 1 according to the invention, and the solid line is assigned to a conventional proportional magnet without the ring. It can be found that in the proportional magnet 1 according to the invention, the force acting on the magnet armature 1 is damped or decreases. The instances of large current ripple shown in FIG. 4 act according to the principle of an eddy current brake, such that a reduction of the force as shown in FIG. 5 occurs as a result.

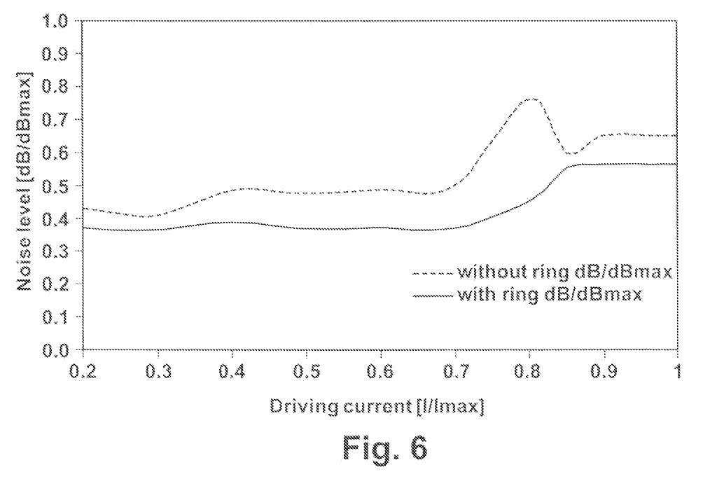

Finally, FIG. 6 shows a resulting noise level as a function of a driving current, wherein these two quantities are in each case normalized to a nominal value (maximum value). In the diagram in FIG. 6, the dashed curve is assigned to a conventional proportional magnet without a ring, and the solid line is assigned to the proportional magnet 1 according to the invention with ring 16. It can be seen that a noise reduction by almost 10 dB results for the proportional magnet 1 according to the invention by comparison with a conventional embodiment without the ring. In this case, the greatest noise improvement is at a comparatively high driving current of approximately 0.8. With regard to a use of the proportional magnet 1 in a servo steering system this is of particular importance because in this range the PWM signal commences and is provided in fully modulating fashion beforehand. In the servo steering system this range arises in particular when the motor vehicle is being parked, idling or stopped, such that, owing to the lack of travel noise, the reduction of the noise emission becomes apparent to the vehicle occupant to an even greater extent.

In the proportional magnet 1 according to one embodiment of the invention, disturbing radial movements of the magnet armature 9 and resultant noise emissions can be prevented or substantially reduced solely by the use of the ring 16, without an increase in the PWM frequency, a sound encapsulation of the magnet armature or similar measures being required in this case. As a result of this simple structural measure, the noise emissions of the proportional magnet can be reduced by up to 30 dB without high additional outlay.

Although specific embodiments have been illustrated and described, it will be appreciated by one of ordinary skill in the art that any arrangement which is calculated to achieve the same purpose may be substituted for the specific embodiment shown. It is to be understood that the above description is intended to be illustrative and not restrictive. The application is intended to cover any variations of the invention. The scope of the invention includes any other embodiments and applications in which the above structures and methods may be used. The scope of the invention should therefore be determined with reference to the appended claims along with the scope of equivalence to which such claims are entitled.

It is emphasized that the abstract is provided to comply with 37 CFR. Section 1.72(b) requiring an abstract that will allow the reader to quickly ascertain the nature and gist of a technical disclosure. It is submitted with the understanding that it will not be used to interpret or limit the scope of meaning of the claims.

What is claimed is:

1. A proportional magnet, comprising:
a winding carried by a coil body;
two pole shoes projecting into the coil body from opposite sides and which are spaced apart axially from one another, wherein a gap is provided between the pole shoes;
a magnet armature arranged within the winding in an axially displaceable manner substantially parallel to the longitudinal axis; and
an electrically conductive element arranged in the gap, wherein the magnet armature is configured to move axially substantially parallel to the longitudinal axis along at least a portion of the electrically conductive element, wherein the electrically conductive element is formed from a basic body having an electrically conductive layer, and wherein the electrically conductive layer is applied separately to the basic body.

2. The proportional magnet as claimed in claim 1, wherein the electrically conductive element comprises a metallic material.

3. The proportional magnet as claimed in claim 1, wherein the basic body and the electrically conductive layer, respectively, have a metallic coating that provides protection against corrosion.

4. The proportional magnet as claimed in claim 3, wherein the metallic coating is formed by the process of chemical tin-plating or electrolytic gold-plating.

5. The proportional magnet as claimed in claim 1, wherein the electrically conductive element comprises one of copper and aluminum.

6. The proportional magnet as claimed in claim 1, wherein the electrically conductive element comprises a ring having a small length, compared to the longitudinal axis of the coil body.

7. The proportional magnet as claimed in claim 6, wherein an internal diameter of the ring is at most as small as an external diameter of the magnet armature, wherein an axial displaceability of the magnet armature through the ring is ensured.

8. The proportional magnet as claimed in claim 6, wherein an external diameter of the ring is at most as large as an external diameter of at least one of the two pole shoes.

9. The proportional magnet as claimed in claim 1, wherein, in the case of a radial movement of the magnet armature out of a center axis of the coil body, a change in the magnetic field occurs within the electrically conductive element and an eddy current that induces a magnetic field is thus generated, therein, such that said magnetic field forces the magnet armature back to the center axis of the coil body.

10. The proportional magnet as claimed in claim 8, wherein the magnetic field lines of the magnetic field induced in the ring are curved with respect to the longitudinal axis of the coil body on account of the small length of the ring such that the magnetic forces acting on the magnet armature in response to the induced magnetic field have radial force components directed in the direction of the center axis of the coil body.
